(19) United States
(12) Patent Application Publication
(10) Pub. No.: US 2005/0119945 A1
(43) Pub. Date: Jun. 2, 2005

(54) Products and processes for regulation of network access and file sharing

(76) Inventors: Andrew Van Luchene, Santa Fe, NM (US); Kevin German, Pittsburgh, PA (US); Avik Mohan, Norwalk, CT (US); Lucian Niemeyer, Eldorado, NM (US)

Correspondence Address: Andrew Van Luchene, 229A Johnson Street, Santa Fe, NM, 87501, US

(21) Appl. No.: 10/895,181

(22) Filed: Jul. 19, 2004

Related U.S. Application Data
(60) Provisional application No. 60/488,431, filed on Jul. 17, 2003.

(51) Int. Cl. G06F 17/60

(52) U.S. Cl. 705/26

(57) ABSTRACT

Products and processes are disclosed for displaying and printing works of art in an improved manner. A server or the like receives a request to print the digital image on a printing device, such as a high quality ink jet or dye sublimation printer. The server also receives payment information for the request to print. The server then determines whether a number of previously-printed prints of the digital image has exceeded a maximum. For example, an artist may have decided that his work of art may only be reproduced in a run of no more than 500 prints. The server authorizes the printing device to print the digital image, and the server records that the digital image was printed.

This application claims the benefit of priority of U.S. Provisional Patent Application No. 60/488,431, filed Jul. 17, 2003, entitled “Method and Apparatus for Selling and Delivering Physical Works of Art That Are Presented in a Digital Format in a Physical Art Gallery”, which is incorporated herein by reference.

### BACKGROUND

The delivery of works of art, particularly prints, has been an expensive and cumbersome process. Many prints have been made in batches and then sold gradually over time by galleries, which take possession of the prints and try to sell them. The labor and resources required to deliver a print to a consumer in this manner reduces the number of prints a particular gallery can display and sell. In addition, the galleries which take possession of prints before they are sold and carefully store them to avoid damaging the prints. Many are nevertheless damaged before they can be sold.

It would be advantageous to display works of art in an improved manner which allowed consumers to view more art without the risk of damage.

### BRIEF DESCRIPTION OF THE DRAWINGS

FIG. 1 is a block diagram of a system overview.

FIG. 2 is a block diagram of a central gallery system.

FIG. 3 is a block diagram of a store system.

FIG. 4 is a table describing an Image Database.

FIG. 5 is a table describing an Image Group Database.

FIG. 6 is a table describing an Exhibit Database.

FIG. 7 is a table describing an Exhibit Rules Database.

FIG. 8 is a table describing an Available Frames Database.

FIG. 9 is a table describing an Artist Database.

FIG. 10 is a table describing a Gallery Database.

FIG. 11 is a table describing a Customer Database.

FIG. 12 is a table describing a Transaction Database.

FIG. 13 is a table describing a Bad Print Database.

### DETAILED DESCRIPTION

Overview

It has very recently become possible through advances in scanning techniques and printers to finally produce prints via computer equipment with a quality that rivals those made by earlier printing processes. The presently disclosed embodiments take advantage of these new abilities in a new combination of functionality.

According to one embodiment, a physical art gallery exhibits artworks in a digital format on flat panel displays (e.g., plasma displays). Consumers can browse through a digital inventory of the prints available in the gallery, select the print they would like to purchase, specify the size of the print, and pay for the print, e.g., on a desktop computer located in the gallery. Once the print has been selected and purchased, the print can be printed in real time on a high quality printer located in the gallery. In addition, a certificate of authenticity, including the limited edition number of the print, may also be printed with the print.

A single central gallery system can control both the exhibits and the digital inventory (e.g., prints of artwork) of more than one physical gallery at the same time. Galleries networked to the central gallery system could subscribe to the various exhibits available in the central gallery system. Each gallery might choose particular exhibits to display based on a library of exhibits provided by the central gallery system.

Similarly, more than one central gallery system may exists, providing a form of competition to the galleries which can subscribe thereto.

The central gallery system has various functionality. For example, the central gallery system can determine if the number of prints sold of a particular artwork has exceeded the limited edition number specified for that artwork. If the number has exceeded the limited edition number, the artwork is no longer made available for sale by the central gallery system. By being able to track the number of prints made for a particular digital image, the central gallery system can allow a number of different physical galleries to sell an edition of prints at the same time.

Similarly, consumers could also log in to a website linked to the central gallery system from any location and select and pay for prints provided by the system. Based on the consumer's location, the central system could instruct the consumer to pick up the print at a physical gallery located near the consumer that is also linked to the central gallery system. The print could automatically be printed by the printer located in the gallery along with an invoice indicating that a consumer will pick up the print. Alternatively, the central system could print the print and mail it to the consumer address.

Millions of important works of art, particularly photographs have not been developed into prints due to the costs involved. Embodiments disclosed herein provide an inexpensive and high quality process of making prints available to consumers as they are sold so that galleries do not have to take physical inventory of prints.

Moreover, there are thousands of galleries in the United States alone. Each gallery typically must develop its own pool of artists whose art the gallery makes available to its consumer base. Many galleries would like to showcase the works of art of more artists, but cannot take the risk due to the costs involved of representing an artist. Embodiments disclosed herein provide diminish the risk of representing new artists by reducing the cost involved of having an opening and exhibit for an artist. Thus, with various embodiments of the present invention, galleries can readily make the works of art of more artists available to their respective consumer bases.

System Details

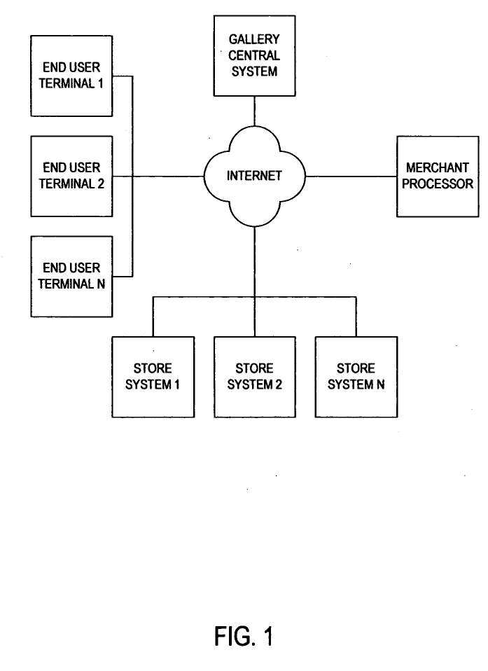

FIG. 1 depicts a system overview 100. A gallery central system 110 is in communication, through a network (such as the Internet and/or well known local area network technologies), with a number of subsystems, most notably a plurality of store systems 120a, 120b, and 120c. Although three store systems are shown in communication with the gallery central system 110, any number of store systems may be so configured. As described herein, each store system is typically responsible for the display and printing of artwork at a physical gallery.

The gallery central system 110 is also in communication with a merchant processor 120 (e.g., a credit card clearinghouse) that effectuates payment. As described herein, such as payment may include payment for artwork by customers, and payment of commissions to galleries and to artists.

The gallery central system 110 is also in communication with end user terminals 130a, 130b and 130c. Although three end user terminals are shown in communication with the gallery central system 110, any number of end user terminals may be so configured. As described herein, each end user terminal is typically responsible for allowing customers to place orders for prints of artwork.

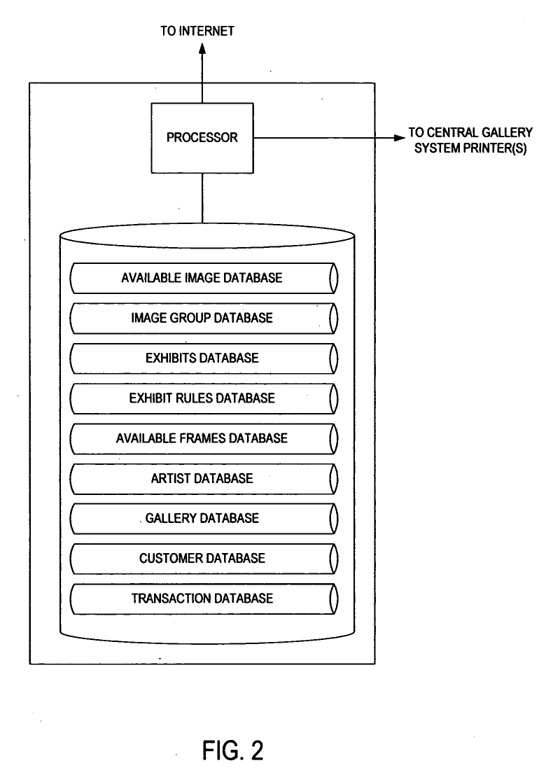

FIG. 2 depicts the gallery central system 110 of FIG. 1 in greater detail. The central system 110 comprises a processor 205 in communication with a storage device 210, which stores various databases for use by the gallery central system. The processor may be one or more conventional microprocessors employed by a conventional server. The storage device may be one or more networked conventional storage devices, such as hard drives, RAIDs and the like.

FIG. 2 also depicts several databases which may be stored by the storage device 210, including an available image database 215, and mage group database 220, an exhibits database 225, an exhibit rules database 230, an available frames database 235, an artist database 240, a gallery database 245, a customer database 250 and a transaction database 255. Each database is described herein. It will be readily apparent to one of ordinary skill in the art that more or less databases as well as different types of databases that may be stored by the storage device.

The gallery central system is operable to receive (e.g., from a store system) a request to print a digital image on a printing device (e.g., a printing device of the store system).

The request typically includes information such as an identifier which identifies the digital image, and a second identifier which identifies either the printing device itself (e.g., by serial number or other unique identifier) or a location of the printing device (e.g., the printing device closest to a specified street address). The request may also include print information such as desired dimensions for the print of the digital image.

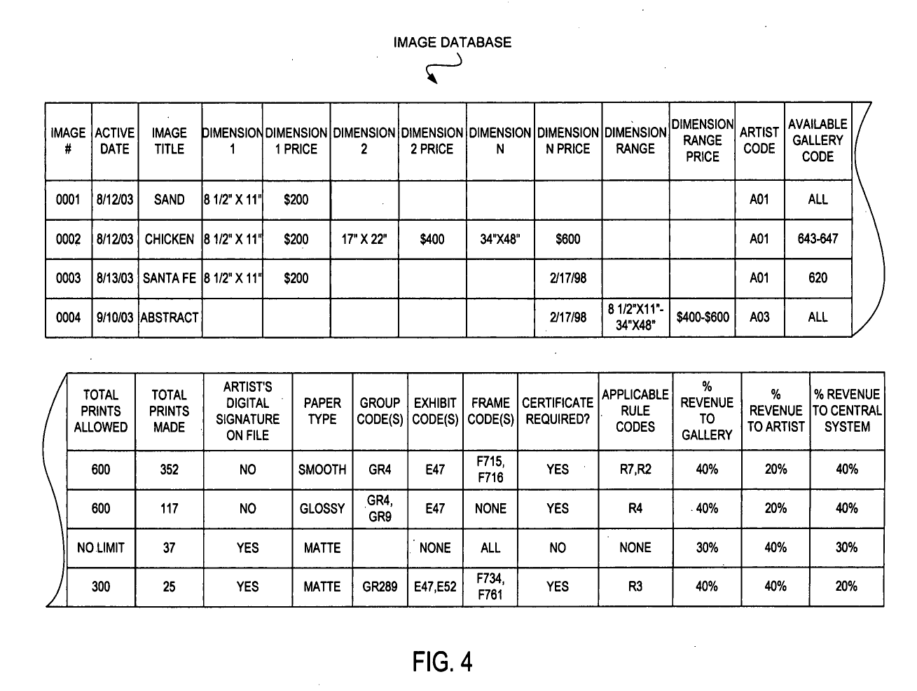

The gallery central system may consult an image database, such as is described herein with respect to FIG. 4 below. Such a database may provide rules governing the printing of images. For example, the rules may dictate whether the particular gallery is authorized to print the particular image, whether any gallery is authorized to print the particular image, and/or whether the digital image may be printed at the desired dimensions.

The rules may dictate other restrictions on the print besides dimensions. For example, the central gallery system may determine characteristics of the printing device (e.g., a resolution of the printing device, a type of paper of the printing device, a printing process used by the printing device, an ink quality of the printing device). Lack of compliance may, e.g., cause the central gallery system to output to the operator of the printing device a warning message (“Please change the type of paper.”).

Each image (and/or each gallery) may have associated therewith minimum standards (e.g., a minimum resolution, at least one acceptable type of paper, at least one acceptable printing process, at least one acceptable ink quality), which the central gallery system determines (e.g., by lookup in the image database, described below with respect to FIG. 4).

According to such an embodiment, the central gallery system would authorize the printing device to print the digital image only if the characteristics satisfy the minimum standards. Alternatively, the central gallery system could authorize the printing device to print the digital image regardless of the characteristics, but could record lack of compliance with the minimum standards (e.g., for subsequent remedial measures including penalty payment).

Similar characteristics of the printing device may be its manufacturer, model number, and/or serial number. Such an embodiment would be advantageous if a gallery were required to use only certain types of printer or other hardware. In some embodiment, the gallery could be restricted to using only a printer (or other device) with a particular serial number.

The gallery system is also operable to receive and process payment information for the request to print. For example, the received payment information may include an account identifier (e.g., for a credit card account of a customer, debit card account of a customer). Alternatively or additionally, the received payment information may include an identifier of a gallery, permitted the gallery itself to be billed. The gallery central system effectuate payment by forwarding the payment information to the merchant processor (FIG. 1) in a known manner.

The central gallery system is also operable to determine whether a number of previously-printed prints of the digital image has exceeded a maximum. For example, it can be desirable to apply a limited edition to an image such that no more than a maximum number of prints may be printed of the image. A number of schemes for assuring that no more that a maximum number are well known. For example, U.S. Patent Application Publication No. 2003/0182475 to Gimenez, which is incorporated herein by reference, discloses such a scheme. More generally, a wide variety of digital rights management schemes are well known and permit the number of prints of a digital image to be limited to no more than a maximum number.

Thus, in one embodiment, determining whether the number of prints of the digital image has exceeded a maximum may comprise determining the number of previously-printed prints of the digital image from a file that is encoded according to a digital rights management scheme. Such a technique will be readily understood by one of ordinary skill in the art. Additionally or alternatively, the central gallery system may store in a database the number of prints made of a digital image, and the maximum permitted. In such an embodiment, determining whether the number of prints of the digital image has exceeded a maximum would comprise determining, from the database, the maximum that is associated with the digital image.

If the number of previously-printed prints of the digital image has not exceeded the corresponding maximum, then the central gallery system authorizes the printing device to print the digital image. In one embodiment, the central gallery system may transmit an authorization (e.g., a code or command) which allows the digital image to be released to the printing device. For example, a server storing the digital images can be authorized to transmit the digital image to the printing device (or a server responsible for managing the printing device). In another embodiment, the central gallery system may itself transmit the digital image to the printing device.

More than the image itself may be printed. For example, a print may include extras such as the artist's digital signature, which is printed with the image (e.g., in a corner of the print) if it is determined that a digital signature is available for the digital image. Similarly, a unique serial number may be generated for the digital image and printed on the print. Depending on various rules, the printing device may be authorized to print the digital signature and/or the unique serial number.

Artists' signatures may be recorded in many known manners, such as by using a digital signature capture device. An artist's signature could be captured in real time as a print is desired by notifying the artist when a print is about to be sold, and having the artist sign the print remotely using a digital signature capture device.

A certificate of authenticity may also be printed, typically on a piece of paper separate from the print of the digital image. If it is determined that a certificate of authenticity is available for the digital image, the printing device may be authorized to print the certificate of authenticity. Such certificates typically include the artist's name, the image name, the artist's signature, the dimensions of the print, a unique certificate number, the image print number, and the customer's name (or the name of another if the print is to be a gift).

Artists could provide blank certificate stock with their signatures on the stock to each gallery. As the gallery sells images, it runs the certificate stock through the certificate printer to print the print name and limited edition number on it.

Such certificates can then be mailed to the purchaser of the print utilizing the customer's address. Mailing the certificate of authenticity from the central system helps ensure that galleries cannot, e.g., duplicate certificates to sell unauthorized prints.

Upon such an authorization to print, the central gallery system may record that the digital image was printed. This is advantageous for maintaining financial records of the transaction, as well as maintaining records for images which are in limited editions. For example, the central gallery system may (i) update a file that is encoded according to a digital rights management scheme to reflect the additional print(s) made, and/or (ii) update a database record which stores the number of prints made of the digital image.

The selection of printing device may be automatic (e.g., all requests through a certain gallery default to printing at the gallery's printer). Alternatively, the selection of printing device may be elected by the customer or otherwise specified for the convenience of the customer. In one embodiment, the customer may enter via a store system (e.g., a kiosk) a requested location (e.g., the customer's address), which is transmitted to the central gallery system. A printing device may be selected by the central gallery system based on this received location.

For example, in selecting the printing device based on the received location, the central gallery system may determine a set of printing devices within a predetermined distance of the received location (e.g., all participating print shops within 10 miles of the received address). A printing device from this set may be selected (by the customer or by the central gallery system) as the printing device which will print the image. Similarly, the central gallery system may selecting the printing device based on the received location (e.g., the closest to the address).

Much like the authorization to print described above, the gallery central system is operable to receive (e.g., from a store system) a request to display a digital image on a display device (e.g., a certain plasma screen) at a destination (e.g., a particular gallery).

The gallery central system determines whether the destination is authorized to display the digital image. For example, the gallery central system may consult an image database, such as is described herein with respect to FIG. 4 below. Such a database may provide rules governing the display of images.

The request to display a digital image on a display device at a destination may include a first identifier which identifies the destination (e.g., a gallery identifier), as well as a second identifier which identifies the digital image (e.g., a unique image code).

In determining whether the destination is authorized to display the digital image, the gallery central system may identify the destination, and determine whether the digital image may be displayed at the destination (e.g., by rule-lookup in an image database to determine whether the particular gallery is currently authorized to display the particular digital image). Additionally or alternatively, the gallery central system may identify the digital image, and determine whether the digital image may be displayed at all (e.g., by rule-lookup in an image database).

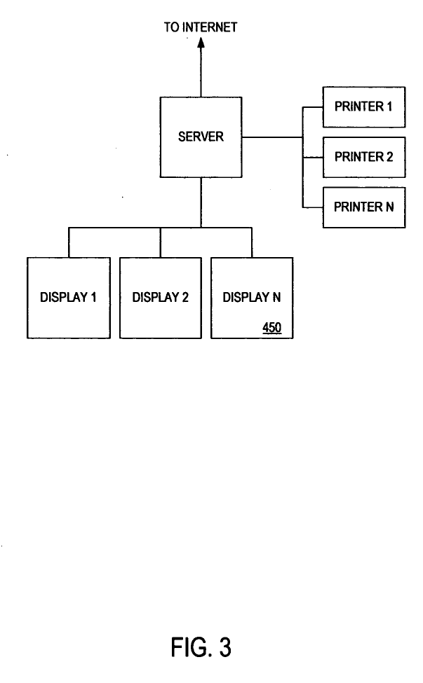

FIG. 3 depicts a store system 300, such as one of the store systems 120a, 120b, and 120c illustrated in FIG. 1. The depicted store system includes a server 310, which may be, e.g., a conventional server computer or personal computer. The server 310 is in communication (e.g., through a network or direct connection such as a serial port) with a plurality of printers 320a, 320b and 320c. The printers are preferably high quality ink jet or dye sublimation printers, such as the Epson Stylus Pro 9600 Series, which are capable of printing at a resolution of 2880×1440 dpi. Although three printers are shown in FIG. 3, any number of printers may be in communication with the server 310.

The server 310 is also in communication (e.g., through a network or direct connection such as a serial port) with a plurality of displays 330a, 330b and 330c. The displays are preferably flat-panel plasma monitors, such as the BenQ 7843E which are capable of displaying at a 1024×768 aspect ratio. Although three displays are shown in FIG. 3, any number of displays may be in communication with the server 310. Displays may include touch screens to allow users to provide commands to the server, such as a command to change the image displayed, or to purchase a print of the image displayed.

The server controls the images displayed on the plurality of displays and the prints made by the plurality of printers in a well known manner.

A store system may serve a physical art gallery, or may be a self-contained kiosk located anywhere. In a kiosk embodiment, a customer could use the display to select images to purchase, and pay for those images. The server 310 would command the printer to print the images. The kiosk could automatically also insert the print into a tube to keep it safe, or a person could manually insert the print into a tube for the customer.

FIG. 4 depicts an image database 400, which includes a plurality of records, each record representing a digital image which may be displayed and/or printed as described herein.

The database of FIG. 4, as well as the other database described herein, are depicted as a table for simplicity of explanation. However, those of skill in the art will understand that many different formats are readily usable for storing and retrieving the information described herein. For example, a single database may actually be implemented as a plurality of databases, or a combination of databases and data files such as Digital Rights Management files. Further, the databases depicted herein describe specific types of information for purposes of illustration and explanation, but those of skill in the art will readily understand that more or less types of data may be stored by and employed in the presently disclosed embodiments without departing from the scope of the present invention. For example, some of the data may represent rules which affect the processing of the data in the record.

Each record of the image database describes various information regarding a digital image. For example, a unique code (“image #”) uniquely identifies each image. An “active date” describes when the digital image has been allowed to be displayed and/or printed. Specific details about the image itself may be stored (e.g., “image title”, dimensions, prices for various dimensions). A record may store the corresponding artist (via a unique “artist code”) who created the artwork.

A record may store information regarding the galleries which may display the image (e.g., “available gallery code”). A record may store information regarding the printing/displaying of the image (e.g., “total prints allowed”, “total prints made”, “artist's digital signature available on file”, “paper type”, “frame code”, “certificate required?”, “applicable rule codes (for printing/displaying)”). A record may store information regarding whether the image is part of a group of images (“group code”) or part of an exhibit (“exhibit code”). Finally, a record may store information regarding the commissions to be paid due to a sale of a print of the image (“% revenue to gallery”, “% revenue to artist”, “% revenue to central system”).

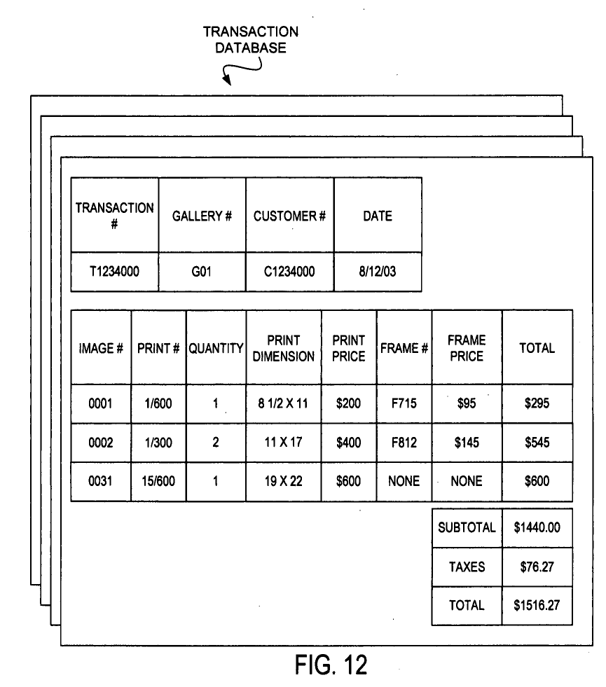

Commissions due may be calculated in a variety of manners consistent with the presently disclosed embodiments. For example, the example information in FIG. 4 describes a fixed percentage of sale price of prints is to be allocated among the gallery, artist and central system. In one embodiment, periodically (e.g., once per month) an image is identified (e.g., as part of an iteration over each image managed by the gallery central system). The number of sales of prints of the image that were made during the time period are determined (e.g., by consulting a transaction database, described below with respect to FIG. 12). A commission is determined based on the number of sales of the prints of the image. The artist corresponding to the image is determined and the artist is notified of the commission. The commission may then be credited to the artist (e.g., a check mailed, submitting via a merchant processor an authorization to credit the commission to the artist).

The artist's commission may be determined in various ways. For each of the sales of prints of the image that were made during the time period, an amount of the respective sale may be determined. For example, an amount due for each sale (e.g., percentage of the print sale price) may be determined, and the amounts due aggregated (e.g., summed).

In another embodiment, the central gallery system may determine, for each respective amount of sales, an amount due based on a predetermined percentage of the respective amount. Then these amounts due may be aggregated.

Each artist could receive different royalties for prints sold based on the print edition, and print desirability. In addition to tracking sales commissions for galleries, the system could also track how much commission is due to an artist on each print sold by the central gallery system.

Commissions for the gallery may be determined in a like manner.

For images sold to customers via a website, where the consumer is directed to a physical gallery located near the consumer's location, a different commission amount could be paid to the gallery than if the customer originated the sale in the gallery. For instance, a physical gallery would receive 30% of the money collected by the central gallery system for a print sold to a customer online and picked up the at the local physical gallery, and a 50% commission otherwise.

Alternatively, each Physical gallery could pay a fixed price for each print and mark up the print for retail as desired. In this embodiment, each physical gallery would be able to control the retail price of the prints they sell.

Besides flat percentages, many other commission structures (e.g., tiered) are included within the scope of the present embodiments.

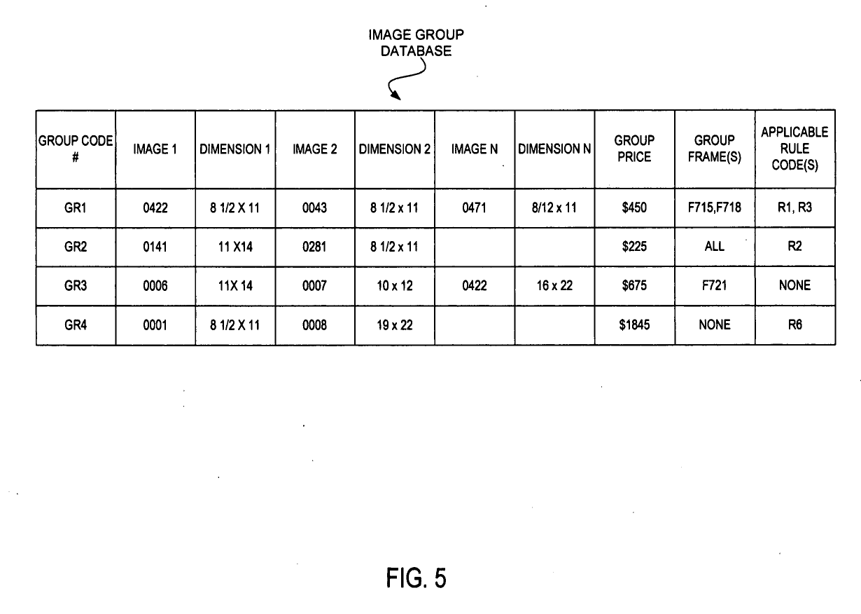

FIG. 5 depicts an image group database 500, which includes a plurality of records. Each record represents a group of digital images which may be displayed and/or printed as described herein. A designation of a group permits a set of artwork (especially related artwork) to be displayed and/or printed together. This can be advantageous for a variety of reasons. For example, the grouping of artwork may serve an aesthetic purpose, may better showcase an artist's range of talents, and/or may better promote sales by affording a single price (possibly a discounted price) for a plurality of prints.

Each record of the image group database describes various information regarding a group of digital images. For example, a unique code (“group code”) uniquely identifies each image group. A record stores the images included within the corresponding group, and corresponding dimensions of each image (“image 1”, “dimension 1”, “image 2”, “dimension 2”, “image N”, “dimension N”). Any number of images may be included in a group, and different groups may include different numbers of images. Similarly, any digital image may belong to more than one group, to one group or to no group at all.

A record may store information regarding a purchase price (“group price”) for the group (i.e. for all images included in the group). A record may store the frames that would be required for such images (“group frame(s)”). Finally, a record may store rules regarding permitted printing/displaying of the images of the group (“applicable rule code(s) (for printing/displaying)”).

A customer may assemble groups of one or more prints and view them in a digital format before they are purchased. Groups of prints could be pre-assembled and stored in the central gallery system, or images stored in the central gallery system can be assembled into groups dynamically by the customer. A group of prints may be sold in limited editions (e.g., no more than a maximum number sold), just as individual images may be so sold. For instance a group of four particular Native American portraits by artist Lucian Niemeyer could be sold individually in editions of no more than six hundred each, or as a group in a group edition of no more than two hundred. A group edition may specify a required size for each image in the group applicable if prints are sold as the group.

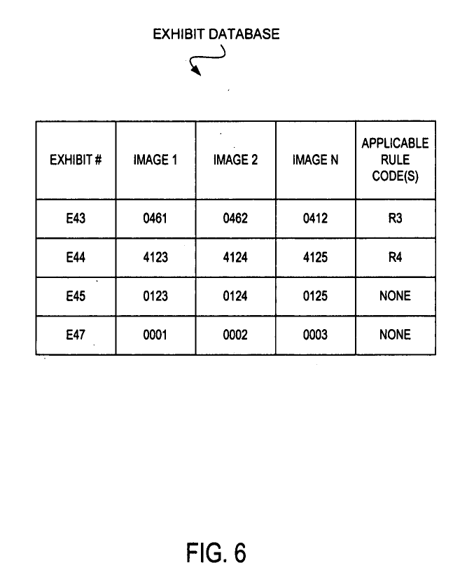

FIG. 6 depicts an exhibit database 600, which includes a plurality of records. Each record represents a group of digital images that may be displayed and/or printed as described herein. A designation of an exhibit permits a set of artwork (especially related artwork) to be displayed together. This can be advantageous for a variety of reasons. For example, the grouping of artwork may serve an aesthetic purpose and/or may better showcase an artist's range of talents.

Each record of the exhibit database describes various information regarding an exhibit of digital images. For example, a unique code (“exhibit #”) uniquely identifies each exhibit. A record stores the images included within the corresponding exhibit (“image 1”, “image 2”, “image N”). Any number of images may be included in an exhibit, and different exhibits may include different numbers of images. Similarly, any digital image may belong to more than one exhibit, to one exhibit or to (atypically) no exhibit at all.

A record may store rules regarding permitted printing or displaying of the images of the group (“applicable rule code(s) (for printing/displaying)”).

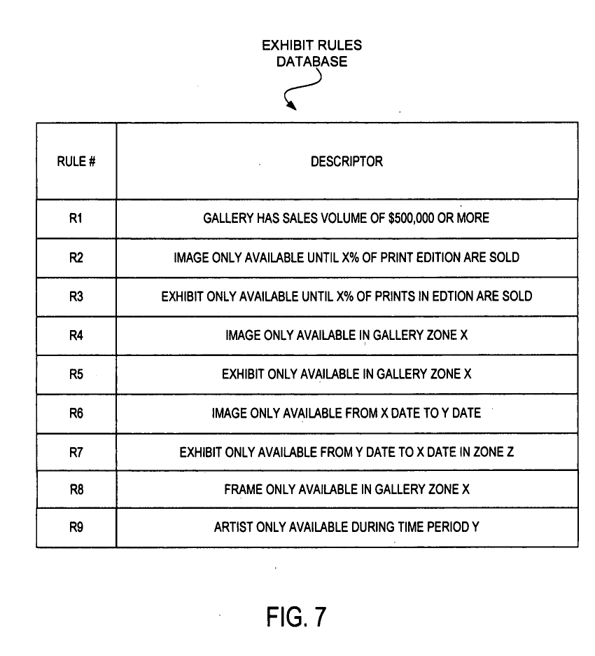

FIG. 7 depicts an exhibit rules database 700, which includes a plurality of records. Each record represents a rule which dictates conditions for the display and/or printing of digital images as described herein. Generally, a rule dictates whether the destination is authorized to display the digital image (e.g., dependent on the gallery sales, sales in the aggregate of the image), restrictions on where the image may be displayed (e.g., in certain gallery zones), restrictions on when the image may be displayed (e.g., between certain dates), restrictions on frame availability, and restrictions on artist availability.

From another perspective, the exhibit rules may define a variety of restrictions, including restrictions that certain exhibits may only be available in certain geographic areas (e.g., in New Mexico), that certain exhibits may only be available in certain galleries (exclusives may be given to certain galleries based on gallery revenue, transaction volume, etc), that certain exhibits may only be available for certain periods of time, and/or that certain exhibits are available only as long as a certain percentage of the prints for the exhibit have not been sold. Such rules may be specified and applied to exhibits for a variety of reason, including financial, marketing and aesthetic purposes.

Those of skill in the art will readily understand that the present invention contemplates may other types of rules governing the display and/or printing of images in an exhibit.

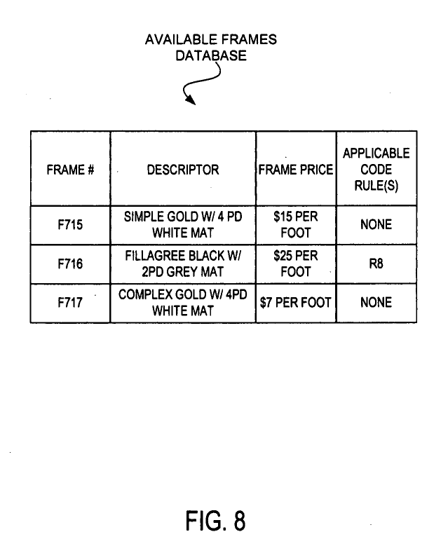

FIG. 8 depicts an available frames database 800, which includes a plurality of records. Each record represents a frame. For example, a unique code (“frame #”) uniquely identifies each frame. A record may store the frame's description (“descriptor”) and price (“frame price”). A record may store rules regarding which frames are required for images and their exhibition (“applicable code rule(s)”).

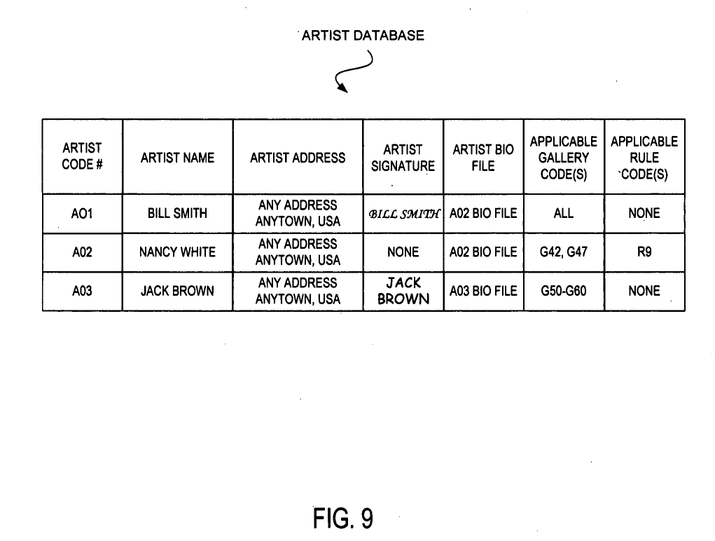

FIG. 9 depicts an artist database 900, which includes a plurality of records. Each record represents an artist. For example, a unique code (“artist code #”) uniquely identifies each artist. A record may store personal information about the artist (“artist name”, “artist address”, “artist bio file”). A record may store an artist's digital signature (“artist signature”) which generally indicates a file storing an image of the artist's signature, for use in printing onto, e.g., the artist's works.

A record may store an indication of which galleries the artist's art may be provided (“applicable gallery code(s)”). A record may store an indication of rules governing the display and/or printing of the artist's works of art (“applicable rule code(s)”).

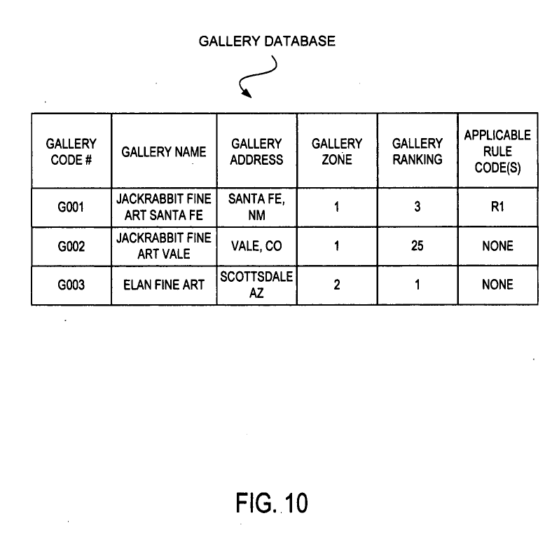

FIG. 10 depicts a gallery database 1000, which includes a plurality of records. Each record represents a gallery that may be served by a store system as described herein. For example, a unique code (“gallery code #”) uniquely identifies each gallery. A record may store descriptive information about the gallery (“gallery name”, “gallery address”, “gallery zone”, “gallery ranking”). A record may store an indication of rules governing the display and/or printing of artwork at the gallery (“applicable rule code(s)”).

A record may store information that permits the gallery central system 110 to provide the equipment of the respective store to receive data (e.g., digital images, authorization codes). For example, a record may store information such as the IP address, network address, serial numbers of equipment used by the gallery.

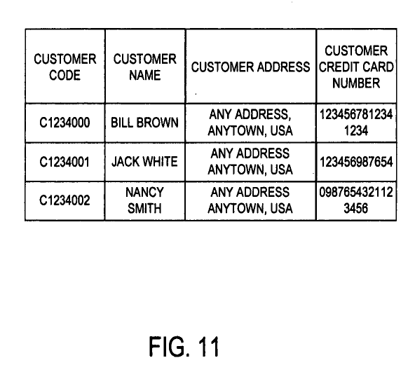

FIG. 11 depicts a customer database 1100, which includes a plurality of records. Each record represents a customer that may be served (e.g., by a store system) as described herein. For example, a unique code (“customer code”) uniquely identifies each customer. A record may store descriptive information about the customer (“customer name”, “customer address”). A record may store information permitting the customer to provide or receive payment (“customer credit card number”) via any known billing or payment mechanism.

FIG. 12 depicts a record 1200 of a transaction database, which includes a plurality of such records. Each record represents a transaction, such as a purchase by a customer of a print of an image. Many other types of transactions are consistent with the presently disclosed embodiments.

Each record of the transaction database may include a unique code (“transaction #”) that uniquely identifies each transaction. The date of the transaction is stored (“date”). In the case of a transaction completed at or via a gallery, the record stores a indication of the gallery or galleries (“gallery #”). In the case of a transaction made with a customer, the record stores the customer or customers (“customer #”).

In the case of a transaction that involves prints of images, such as the purchase of one or more prints of one or more images, the record stores data regarding such prints (“image #”, “print #”, “quantity”, “print dimension”, “print price”, “frame number”, “frame price”). A record may also store particulars of financial information (e.g., “total”, “subtotal”, “taxes”, “total price”). Such accounting records may be readily processed in a variety of known manners by many types of well known accounting products.

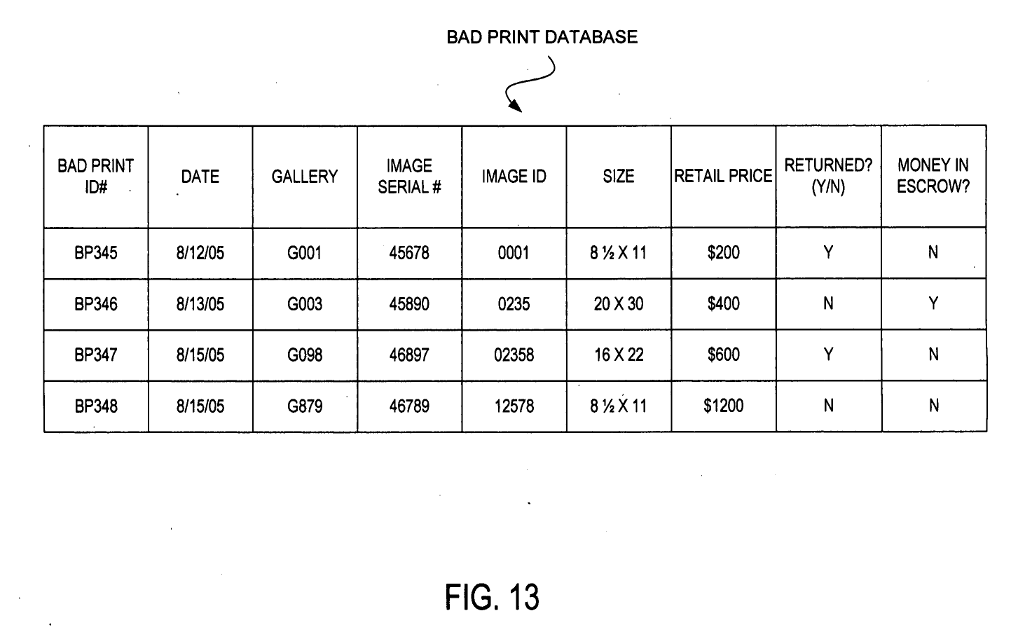

FIG. 13 depicts a bad print database 1200, which includes a plurality of records. Each record represents a print that is deemed (provisionally or finally) to be a “bad print”, as described herein. For example, a unique code (“bad print ID#”) uniquely identifies each bad print. A record may store descriptive information about the bad print (“date printed”, “gallery at which it was printed”, “image serial #”, “image ID”, “size of print”, “retail price”). A record may store information regarding the status of the bad print, including whether the gallery central system has verified that the print is indeed a bad print (“returned? (Y/N)”, “money in escrow”).

To manage bad prints, the central gallery system may receive, from a printing device (e.g., a store system), a request for a duplicate print to be made of a digital image. Preferably, the central gallery system determines an individual that requested the duplicate print, such as by a unique identifier (gallery identifier, gallery employee identifier). In response to the request, the central gallery system may transmit to the printing device an authorization for a test print of the digital image.

An indication that the test print succeeded may be received from the printing device. If so, a new identifier s assigned to the duplicate print to be made by the printing device of the digital image. The printing device is also authorized to print the digital image, as described herein.

The identifier previously associated with the print made of the digital image via the same printing device is determined (e.g., by database lookup). The previous identifier is recorded as being associated with a bad print. Commissions for prints are determined by excluding the commissions due to bad prints.

The bad print is to be mailed from the gallery (or other location) to the central gallery system. Upon receiving an indication that a bad print corresponding to the previous identifier has been received, the bad print is released as recovered, rather than potentially circulating.

Various alternatives to the above described particulars are within the scope of the present invention. For example, galleries (and other outlets) can sell display screens to customers who in turn subscribe to content that is shown on those screens. Custom content packages can be created by the customer and shown on the plasma screens. Customers could select the content to be displayed on the image, could select categories of content they are interested displaying on the images, or could allow the system to select the content that is displayed on the images.

In another embodiment, display screens could show moving images that a customer or the system may stop (periodically or otherwise) and/or print. The system could allow the customer to print a limited number of the same image in this manner. The system could also only allow a limited number of prints that contained certain objects to be printed. For instance an image of a farmer's market with several farmers and customers could be built in a three-dimension modeling program. The farmers and customers interact with one another and the system could freeze the moving image to allow the customer to make a print of the still image. There could be a limited number for each still image created, such as a limit of five prints of a single still. Alternatively, there could be a limited number of prints created that contain a particular farmer and a particular customer. In yet another embodiment, there could be a limited number of prints generated from the same scene.

In another embodiment, galleries could sell sculptures in a similar manner to images. Sculpture designs saved in a three-dimensional modeling software program such as AutoCAD or 3Dstudio Max could be viewed on a website by a customer. The customer could select a sculpture that he would like to purchase and pay for it. A laser cutter device could sculpt a block of resin or other lasting material into the form specified by the sculpture design.

Many other embodiments not explicitly described herein are contemplated by the present invention and encompassed by the claims which follow and which may be subsequently added.

1. A method comprising:
receiving a request to print a digital image on a printing device;
receiving payment information for the request to print;
determining whether a number of previously-printed prints of the digital image has exceeded a maximum;
authorizing the printing device to print the digital image; and
recording that the digital image was printed.

2. The method of claim 1, further comprising:
receiving a request to display a digital image on a display device at a destination; and
determining whether the destination is authorized to display the digital image.

3. The method of claim 2, in which the request to display a digital image on a display device at a destination includes:
a first identifier which identifies the destination; and
a second identifier which identifies the digital image.

4. The method of claim 2, in which determining whether the destination is authorized to display the digital image comprises:
identifying the destination; and
determining whether the digital image may be displayed at the destination.

5. The method of claim 2, in which determining whether the destination is authorized to display the digital image comprises:
identifying the digital image; and
determining whether the digital image may be displayed.

6. The method of claim 2, in which determining whether the destination is authorized to display the digital image comprises:
determining, based on a database entry, whether the destination is authorized to display the digital image.

7. The method of claim 1, in which the request to print the digital image on a printing device includes:
a first identifier which identifies the digital image; and
a second identifier which identifies at least one of
a location of the printing device, and
the printing device.

8. The method of claim 1, in which the payment information comprises at least one of:
an identifier of a gallery; and
an identifier of a credit card account.

9. The method of claim 1, in which determining whether the number of prints of the digital image has exceeded a maximum comprises:
determining the number of previously-printed prints of the digital image from a file that is encoded according to a digital rights management scheme.

10. The method of claim 1, in which determining whether the number of prints of the digital image has exceeded a maximum comprises:
determining, from a database, the maximum that is associated with the digital image.

11. The method of claim 1, in which authorizing the printing device to print the digital image comprises:
transmitting authorization which allows the digital image to be released to the printing device.

12. The method of claim 1, in which authorizing the printing device to print the digital image comprises:
transmitting the digital image to the printing device.

13. The method of claim 1, in which recording that the digital image was printed comprises:
updating a file that is encoded according to a digital rights management scheme.

14. The method of claim 1, further comprising:
receiving dimensions for the print of the digital image.

15. The method of claim 14, further comprising:
determining whether the digital image may be printed at the received dimensions.

16. The method of claim 1, further comprising:
determining if a digital signature is available for the digital image; and
determining if a unique number is available for the digital image.

17. The method of claim 16, in which authorizing the printing device to print the digital image comprises:
authorizing the printing device to print at least one of the digital signature and the unique number.

18. The method of claim 1, further comprising:
determining if a certificate of authenticity is available for the digital image.

19. The method of claim 18, in which authorizing the printing device to print the digital image comprises:
authorizing the printing device to print the certificate of authenticity.

20. The method of claim 1, further comprising:
selecting the printing device based on a received location.

21. The method of claim 20, in which selecting the printing device based on a received location comprises:
determining a set of printing devices within a predetermined distance of the received location; and
selecting the printing device from the set of printing devices.

22. The method of claim 1, further comprising:
selecting the printing device based on a received location.

23. A method comprising:
identifying a gallery;
determining, for each print sold via the gallery during a time period, a method of sale of the respective print;
determining a commission based on the methods of sales of the prints; and
notifying the gallery of the commission.

24. The method of claim 23, in which determining a commission based on the methods of sales of the prints comprises:
determining, for each print sold via the gallery during the time period, an amount due based on the method of sale of the respective print; and
aggregating the amounts due.

25. The method of claim 23, further comprising:
determining, for each print sold via the gallery during the time period, an amount for which the respective print was sold.

26. The method of claim 23, further comprising:
crediting the commission to the gallery.

27. The method of claim 23, further comprising:
submitting an authorization to credit the commission to the gallery.

28. The method of claim 23, in which the steps of the method of claim B are performed at least once per month for the identified gallery.

29. A method comprising:
receiving, from a printing device, a request for a duplicate print to be made of a digital image;
transmitting, to the printing device, an authorization for a test print of the digital image;
receiving, from the printing device, an indication that the test print succeeded;
assigning a new identifier to the duplicate print to be made by the printing device of the digital image.
authorizing the printing device to print the digital image.

30. The method of claim 29, further comprising:
determining a previous identifier associated with the print to be made of the digital image via the printing device; and
recording the previous identifier as being associated with a bad print.

31. The method of claim 30, further comprising:
determining commissions for prints by excluding the commissions due to bad prints.

32. The method of claim 30, further comprising:
receiving an indication that a bad print corresponding to the previous identifier has been received.

33. The method of claim 29, further comprising:
determining an individual that requested the duplicate print.
